(19) United States
(12) Patent Application Publication
(10) Pub. No.: US 2007/0261715 A1
(43) Pub. Date: Nov. 15, 2007

(54) Washing Machine and Method Thereof

(75) Inventors: Deug Hee Lee, Gyeongsangnam-do (KR); Seung Bong Choi, Gyeongsangnam-do (KR); Byung Hwan Ahn, Gyeongsangnam-do (KR); Hung Myong Cho, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu, Seoul (KR)

(21) Appl. No.: 10/555,445

(22) PCT Filed: Jun. 9, 2005
(86) PCT No.: PCT/KR05/01727

§ 371 Date: Mar. 12, 2007

(30) Foreign Application Priority Data
Jun. 23, 2004 (KR) 10 2004 0047189
Jun. 23, 2004 (KR) 10 2004 0047188
Jun. 23, 2004 (KR) 10 2004 0047190
Jun. 23, 2004 (KR) 10 2004 0047187

(51) Int. Cl. B08B 3/00; B08B 7/04; D06F 21/00; D06F 35/00

(52) U.S. Cl. 134/30; 134/31; 134/33; 68/3 R; 68/5 C

(57) ABSTRACT

A laundry device and a method thereof are disclosed. The laundry device includes a body, a drum provided in the body, thereon a circumferential surface a plurality of holes having each diameter of less than 1 mm being formed and a motor driven for rotating the drum at high speed of at least 2000 RPM. The method of the laundry device includes a (a) step for supplying steam to an inside of a drum where the laundry is introduced, a (b) step for stopping steam supply after a predetermined period of time and a (c) step for centrifugally separating contaminants from the laundry by rotating the drum at high speed. The method includes and performs in regular sequence a (h) step for performing a washing cycle for a predetermined period of time, a (i) step for performing at least one and more rising cycle when the (h) step is completed, a (j) step for performing a final spinning cycle by rotating a drum at high speed when the (i) step is completed and a (k) step for performing a dry cycle by rotating the drum at higher speed than the speed in the final spinning cycle when the final spinning cycle is completed.

### TECHNICAL FIELD

The present invention relates to a laundry device, and more particularly, to a laundry device and a method thereof for performing washing process with a small amount of washing water and with low power consumption. The present invention also relates more particularly to a laundry device and a method for performing washing process with minimizing damage to the laundry regardless of kinds of the laundry texture.

### BACKGROUND ART

Generally, a laundry device is classified into two types, a pulsator type and a drum type. In the pulsator type, a drum is stood in a vertical direction, and in the drum type washing machine, a drum is in a horizontal direction.

Since that, the drum type washing machine performs entire washing process by dropping the laundry introduced in a drum inside.

FIGS. 1 and 2 schematically illustrate a diagram of a related art of a drum type washing machine.

That is, the drum type washing machine comprises a body 10, an outer tub 20 installed in the body 10, a drum 30 rotatablely mounted in the outer tub 20 and a driving means which drives the drum 30.

An opening 11 for introduction of laundry is formed in a front surface of the body 10, a door 40 is mounted at a side of the opening 11 for opening/closing the opening 11.

Therewith, a rim part 50 is installed between the opening 11 and the drum 30.

A damper 21 is provided on both below sides of an outside circumference of the outer tub 20, thereby the outer tub 20 being supported.

The driving means includes a motor 71 driving the drum 30 and a belt 72 connected to a belt pulley 73 so as to transmit driving force of the motor 71 to the drum 30.

Recently, a drying apparatus is installed in a washing machine so as to dry the washed laundry.

As shown in FIG. 3, the drying apparatus comprises a hot air supplying pipe 81 provided along an upper side of the outer tub 20 in the body 10, a drying heater 82 provided in the air supplying pipe 81 heating air flowed through the hot air supplying pipe 81 and a fan 83 provided on an air outlet of the hot air supplying pipe 81 performing air circulation.

The drum type washing machine for a combined use of drying performs 4 cycles in regular sequence such as a washing cycle, a rinsing cycle, a final spinning cycle and a drying cycle.

That is, when the user requests washing the laundry, a controller (not shown) controlling operation performs the 4 cycles in regular sequence.

In the washing cycle, contaminants not only by detergent but also by friction between the drum 30 and the laundry according to the consistent rotation of the drum are separated.

In the rinsing cycle, remaining detergent and contaminants generated from the process of both supplying new washing water and the repeated rotation of the drum 30 are separated and rinsed.

In the final spinning cycle, the drum 30 is rotated at high speed of approximate 800 RPM˜1300 RPM, thereby dehydrating the rinsed laundry.

In the drying cycle, a high temperature air is supplied to the inside of the drum 30 by generated heat from a drying heater 82 and by a fan 83 driving, thereby drying the laundry with the high temperature air.

The above conventional laundry device and the method thereof may have the following problems.

First, the above conventional laundry device and the method thereof need consumption of a much amount of washing water and electric power for a washing cycle and a rinsing cycle.

Second, the above conventional laundry device and the method thereof need many cycles such as a washing cycle, a rinsing cycle, a final spinning cycle and a drying cycle, thereby causing that entire washing time is prolonged.

Third, in the above conventional laundry and the method thereof, the time of each cycle is prolonged and/or shortened according to a laundry amount. However, there is no time difference according to a contamination degree of the laundry.

Fourth, the above conventional laundry device and the method thereof need a supplementary drying device for a drying cycle, thereby causing not only additional production cost but also a problem that a structure inside the body may be complicated by the application of the drying device

Moreover, it takes a long time to accomplish dryness to a degree that the user expects. Also, heat generation from the drying heater 82 and driving of the fan 83 are operated at the same time for the long time described above, resulting in consuming much electric power.

Fifth, the above conventional laundry device and the method thereof need extra ironing, since a general washing process generates many pleats.

When a drying cycle is performed in the drum 30 in spite of many pleats, the pleats are deepened causing the ironing more difficult.

Finally, the above conventional laundry device and the method thereof may not obtain an efficiency to prevent static electricity of the laundry.

### DISCLOSURE

### Technical Problem

An object of the present invention is to provide a laundry device and a method thereof for washing the laundry with a small amount of washing water and with low power consumption.

Another object of the present invention is to provide a laundry device and a method thereof for drying the laundry without providing a supplementary drying device.

Another object of the present invention is to provide a laundry device and a method thereof for performing entire washing with minimizing damage to the laundry regardless of kinds of texture.

### Technical Solution

To achieve these objects and other advantages and in accordance with the purpose of the invention, as embodied and broadly described herein, a laundry device comprises a body; a drum provided inside of the body for being rotated, thereon a plurality of holes of which each diameter is less than 1 mm being provided; and a motor driven to rotate the drum at high speed of at least 2000 RPM.

On a circumferential surface of the drum, are further formed at least one or more holes having each diameter of more than 1 mm.

The number of the holes having each diameter of more than 1 mm is smaller than the number of the holes having each diameter of less than 1 mm.

The drum is installed more and more inclined downward as approaching from a front surface to a rear surface, and on a front circumferential surface of the drum may be further formed a plurality of holes having each diameter of more than 1 mm.

An opening for laundry introduction of the drum is mounted facing an upper part and on an upper circumferential surface of the drum may be further formed a plurality of holes having each diameter of more than 1 mm.

The motor is provided in order that the drum may be rotated at speed of 3000˜4000 RPM.

A steam supply part may be further provided in the body evaporating high temperature steam into the drum.

A fluid detergent supply part may be further provided in the body spraying fluid detergent into the drum.

A washing water spry part may be further provided in the body spraying washing water into the drum.

In an aspect of the present invention, a washing method of the present invention includes a (a) step for supplying steam to inside of a drum in which the laundry is introduced; a (b) step for stopping steam supply after a predetermined period of time; and a (c) step for rotating the drum at high speed in order to centrifugally separate contaminants from the laundry.

In the (a) step, the temperature of the supplied steam may be higher than a temperature at which the laundry may be sterilized.

In the (b) step, the predetermined period of time may be a time that the laundry may be soaked.

In the (b) step, the high speed may be 2000˜4000 RPM.

A (d) step for transpiring the steam in the drum may be further included and the (c) step and the (d) step may be alternately operated at relatively lower speed than the drum speed.

In the (d) step, the speed may be lower than 100 RPM.

Operation time for the (d) step may be shorter than the operation time for rotating the drum.

Before supplying the steam of the (a) step to the drum inside, a (e) step for spraying washing water into the drum may be further included.

In the (e) step, the sprayed washing water may be cold washing water not boiled.

Before the (e) step being performed, a (f) step for supplying fluid detergent to the laundry may be further included.

The detergent supplied in the (f) step may be concentrated detergent in fluid state.

After performing the (f) step, a (g) step for rinsing the laundry by spraying steam or washing water into the drum may be further included.

During the first step, the drum may be rotated at low speed.

In another aspect of the present invention, another washing method of the present invention includes a (h) step for performing a washing cycle for a predetermined period of time; a (i) step for performing at least one and more rinsing cycles when completing the washing cycle; a (j) step for performing a final spinning cycle by rotating a drum when completing the final rinsing cycle; and a (k) step for performing a drying cycle by rotating a drum at higher speed than the speed of the spinning cycle

In the (j) step, the rotating speed of the drum may be set up between 600 RPM and 2000 RPM.

In the (k) step, the rotating speed of the drum may be set up between 3000 RPM and 4000 RPM.

When completing the (k) step, a (l) step may be further included for spraying steam to the dried laundry of the drum inside.

In the (l) step, a temperature of the sprayed steam may be higher than a temperature at which the laundry can be sterilized.

The (l) step may be performed for a predetermined period of time when the washed laundry may be refreshed.

### Advantageous Effects

A laundry device and a method thereof according to the embodiments of the present invention have an advantageous effect that the entire washing is performed by the centrifugal force according to the drum rotation, thereby minimizing washing water consumption and electricity consumption.

Additionally, a laundry device and a method thereof according to the embodiments of the present invention have an advantageous effect that damage to the laundry caused by the laundry stuck in the holes according to the centrifugal force of the drum rotation may be minimized by forming each diameter of the holes less than 1 mm.

A laundry device and a method thereof according to the embodiments of the present invention form holes having each diameter of less than 1 mm in a portion not influenced most by the laundry when rotating the drum at high speed, thereby having an advantageous effect of smoothly discharging contaminants and moisture separated from the laundry by the centrifugal force.

A laundry device and a method thereof according to the embodiments of the present invention have an advantageous effect of drying the laundry without a supplementary drying device because moisture contained in the laundry is centrifugally separated by the drum rotation at high speed.

A laundry device and a method thereof according to the embodiments of the present invention have an advantageous effect that the drum is controlled in order that the drum rotation at high speed and the drum rotation at low speed may be alternately performed, thereby preventing re-contamination of the laundry by contaminants and enhancing entire washing capability.

A washing machine and a method thereof according to the embodiment of the present invention have an advantageous effect of preventing reliability of the drum from deteriorating when rotating the drum at high speed, thereby obtaining the maximized drying capability because the drying cycle using the drum rotation at high speed is performed after the spinning cycle is completed.

A washing machine and a method thereof according to the embodiments of the present invention have an advantageous effect of generating anions by spraying steam into the dried laundry, thereby eliminating static electricity and ill-smell components.

A washing machine and a method thereof according to the embodiments of the present invention have an advantageous effect of sterilizing again the dried laundry, thereby enhancing sterilization efficiency.

A washing machine and a method thereof according to the embodiments of the present invention have en advantageous effect of refreshing the dried laundry, thereby accomplishing the suitable state for ironing.

### DESCRIPTION OF DRAWINGS

FIG. 1 illustrates a longitudinal section showing an inside structure of a related art drum type washing machine;

FIG. 2 illustrates a front section showing an inside structure of a related art drum type washing machine;

FIG. 3 illustrates a front section showing an inside structure of a related art drum type washing machine for combined use of drying;

FIG. 4 illustrates a longitudinal section showing an inside structure of a drum type washing machine according to an embodiment of the present invention;

FIG. 5 illustrates a longitudinal section of another embodiment of FIG. 4;

FIG. 6 illustrates a front section showing an inside structure of a drum type washing machine according to an embodiment of the present invention;

FIG. 7 illustrates a flow chart for describing an operating method of a laundry device according to a first embodiment of the present invention;

FIG. 8 illustrates a flow chart for describing an operating method of a laundry device according to a second embodiment of the present invention;

FIG. 9 illustrates a flow chart for describing an operating method of a laundry device according to a third embodiment of the present invention;

FIGS. 10 and 11 illustrate flow charts each for describing an operating method of a laundry device according to a fourth embodiment of the present invention;

FIG. 12 illustrates a longitudinal section showing an inside structure of a drum type washing machine according to another embodiment of the present invention;

FIGS. 13 and 14 illustrate flow charts each for describing an operating method of a laundry device according to a fifth embodiment of the present invention;

FIGS. 15 and 16 illustrate longitudinal sections each showing an inside structure of a drum type washing machine according to anther embodiment of the present invention;

FIGS. 17 and 18 illustrate flow charts each for describing an operating method of a laundry device according to a sixth embodiment of the present invention; and

FIG. 19 illustrates a longitudinal section showing an inside structure of a pulsator type washing machine according to an embodiment of the present invention.

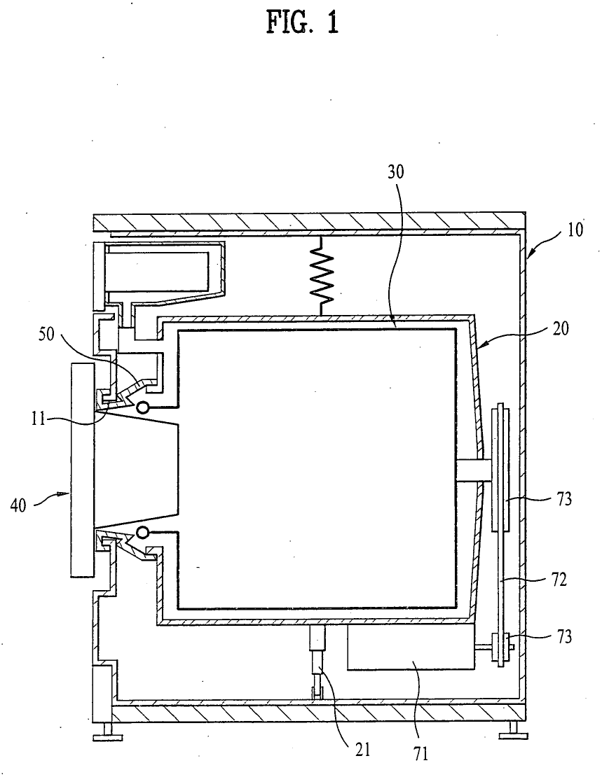

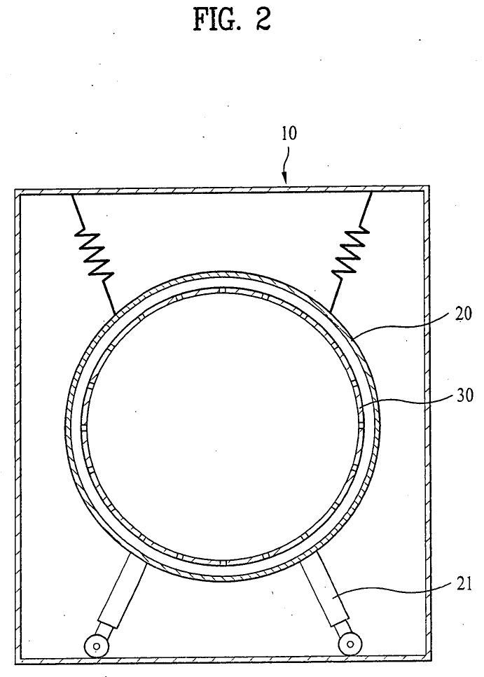

### BEST MODE

Reference will now be made in detail to the preferred embodiments of the present invention, examples of which are illustrated in the accompanying drawings. Wherever possible, the same reference numbers will be used throughout the drawings to refer to the same or like parts.

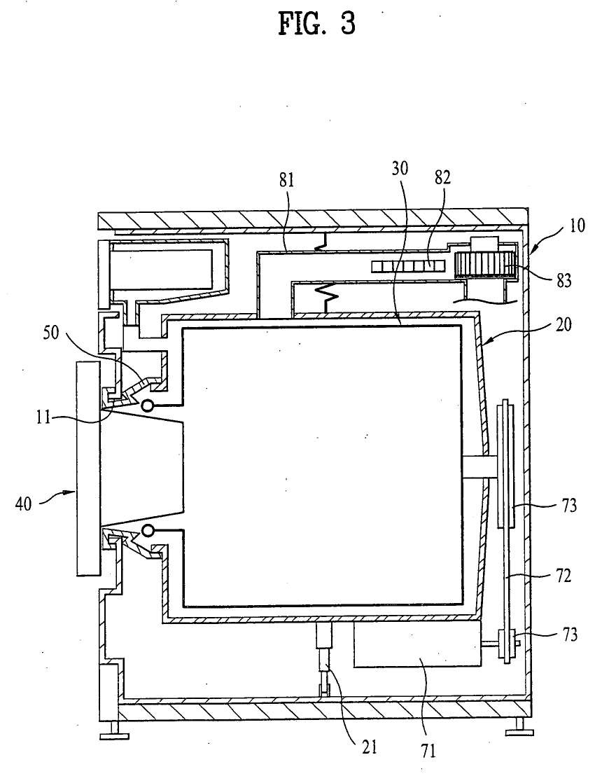

As shown in FIG. 3, a laundry device according to an embodiment of the present invention comprises a body 110, an outer tub 120, a drum 130, a motor 171, and a steam supply part supplying steam to the drum inside.

The body 110 forms the external appearance of a drum washing machine and the outer tub 120 is provided being supported on an inside of the body 110.

The drum 130 is rotatablely mounted on an inside of the outer tub 120, thereof an opened side installed facing an opening 111 of the body 110.

A door 140 opening/closing the opening 111 is installed in the portion where the opening 111 of the body 110 is formed, and a rim part 150 is installed between the opening 111 and the opened side of the drum for laundry introduction.

A plurality of holes 131 having each diameter of smaller than 1 mm D1 is formed along a circumferential surface of the drum 120.

The reason is to minimize damage to the laundry why each diameter of the plurality of holes 131 is less than 1 mm.

If each diameter of the holes 131 were 2˜3 mm just like each diameter of the holes 31 of a conventional drum 30, the laundry would be stuck in the 131 when the drum 130 is rotated at speed of more than 2000 RPM, thereby causing damage to the laundry.

Accordingly, it is preferred but not necessary that each hole 131 is formed to have its diameter of less than 1 mm so as to prevent the laundry from being stuck.

The holes 131 having each diameter of less than 1 mm may be formed more than the holes 31 of the conventional drum 30 in order to smoothly discharge moisture separated from the laundry in the drum 130.

All of the holes 131 are not limited to be formed having their diameters of less than 1 mm. Some of the holes 132 may have their diameters of more than 1 mm, 2˜3 mm D2 the same as the diameter of each hydrating holes 31 is 2˜3 mm.

The holes 132 having each diameter of more than 1 mm are to smoothly discharge moisture separated from the laundry to an outer tub 120. However, the number of the holes 132 having each diameter of more than 1 mm should be smaller than the number of the holes 131 having each diameter of less than 1 mm in order to minimize damage to the laundry.

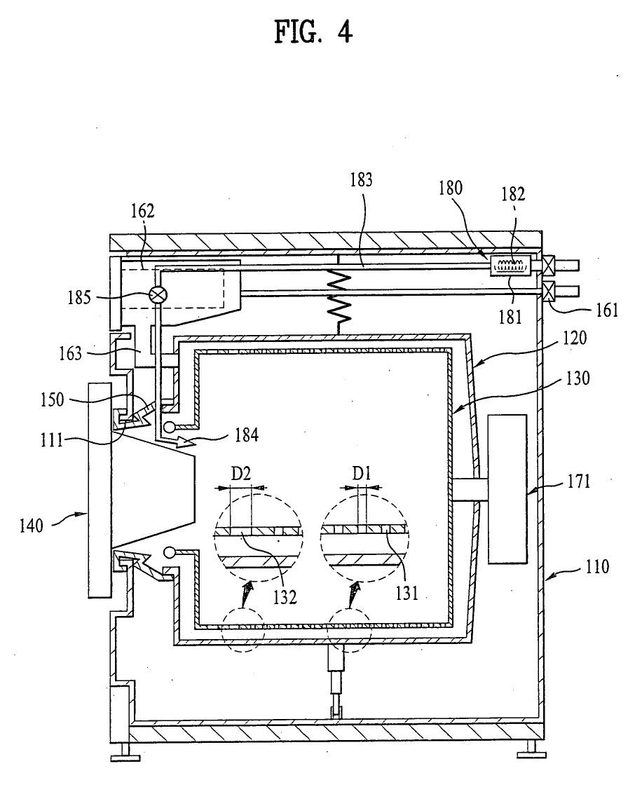

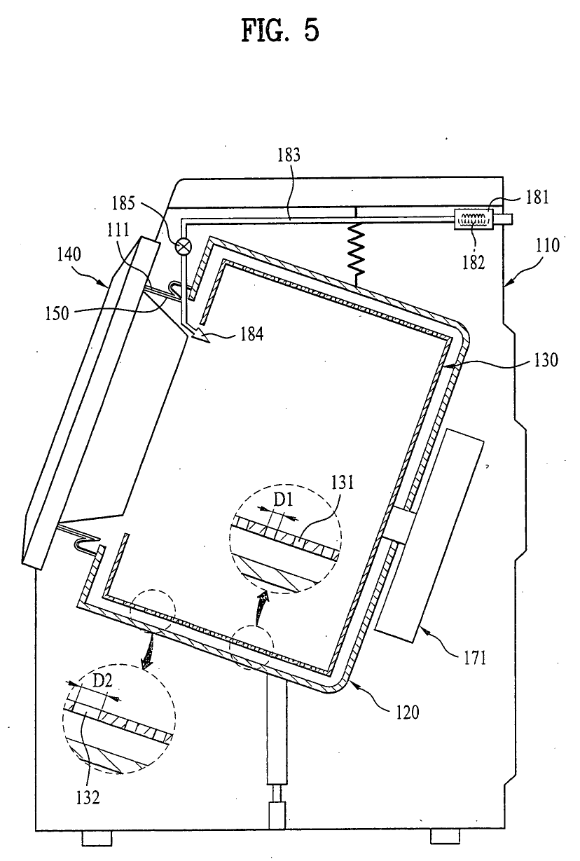

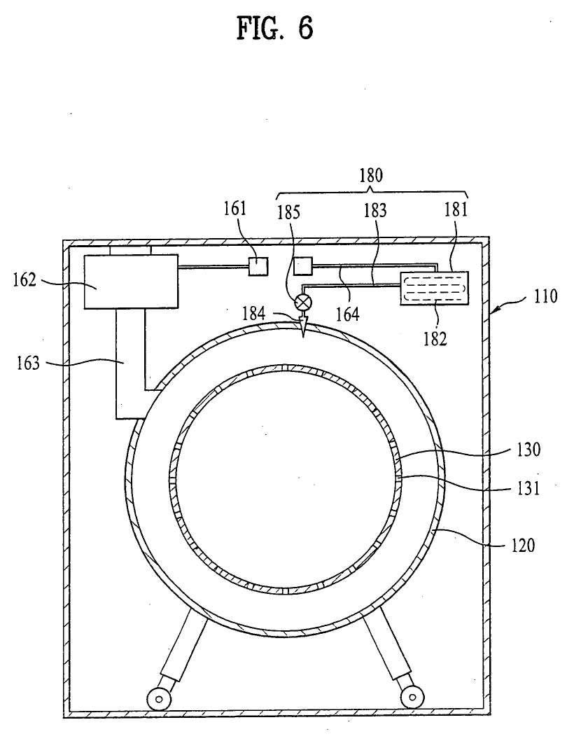

Also, as shown in FIG. 4, the drum 130 may be installed perpendicular to the body 110 to accomplish lying state, however as shown in FIG. 5, the drum 130 may be installed more inclined downward coming along from a front surface, an opened side for introduction of the laundry, to a rear surface, a combined side with a motor.

As described above when the drum 130 is installed more inclined downward coming along from a front surface to a rear surface, the laundry is on a rear surface in a washing cycle. Thus, the holes 131 having each diameter of less than 1 mm may be formed on a rear circumferential surface of the drum 130, while the holes 132 having each diameter of more than 1 mm may be formed on a front circumferential surface much less influenced by the laundry.

The motor 171 is driven to rotate the drum 130.

A structure for supplying driving force by the drum 130 may employ a belt 72 and a belt pulley 73 just like in a conventional technical feature. However, in a laundry device according to an embodiment of the present invention, the motor 171 is directly combined by a shaft to the drum 131.

Considering the motor 171 should rotate the drum 130 at speed of at least 2000 RPm, the motor may be installed minimizing the driving power loss.

In a laundry device according to an embodiment of the present invention, the motor 171 is a motor capable of rotating the drum 130 to speed of 3000˜4000 RPM.

The reason why the motor 171 is provided for rotating the drum 130 at high speed is that moisture containing contaminants can be separated from the laundry by the centrifugal force by the rotation of the drum 130 at high speed, thereby the entire washing accomplished. The steam supply part 180 is a kind of a structure for soaking the laundry with a small amount of water.

The steam supply part 180 generates high temperature steam and sprays the steam in the drum 130. In other words, high temperature steam supplied by the stem supply part 180 may make the laundry soaked without difficulty.

The steam supply part 180 is installed to supply vaporized water by high temperature heat to the inside of the drum 130. The steam supply part 180 comprises a water storage tub 181 therein washing water for steam generation flowing, a heat generation part 182 provided in the water storage tub 181 for vaporizing water by supplying hot air, and a steam supply pipe 183 therein steam being vaporized by the heat generation part 182 flowing.

In the steam supply part 180, a spraying nozzle 184 is further comprised for spraying steam flowing through the steam supply pipe 183 into the drum 130.

The spraying nozzle 184 is formed in a nozzle appearance for spraying steam without difficulty and an end of the spraying nozzle 184 therein the steam being transpired is installed toward inside of the drum 130 after passing through a rim part 150.

The steam supply part 180 is capable of selectively spraying steam, so that an opening/closing valve 185 is further comprised in the steam supply pipe 193 for opening/closing the pipe.

161 (no description) is a valve for water supply connected to a water pipe, 162 (no description) is a detergent box supplying detergent, 163 (no description) is a water pipe leading washing water in the drum 130 and 164 (no description) is a connection pipe supplying washing water to the water storage tub 181 of the steam supply part 180.

Each embodiment for a operating method using a laundry device according to an embodiment of the present invention described above is the followings.

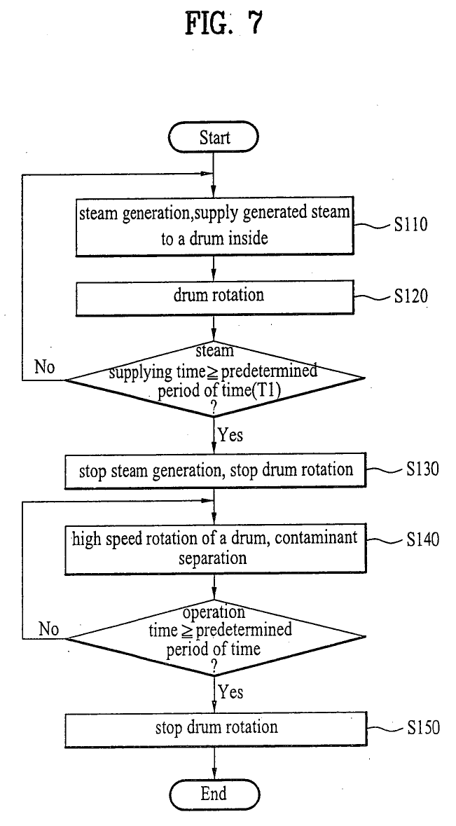

As shown in a flow chart in FIG. 7, an operating method of a laundry device according to a first embodiment of the present invention performs washing the laundry by performing a steam supply step and a contaminant separation step in a regular sequence.

The steam supply step is for soaking the laundry introduced in a drum 130.

Through control of a steam supply part 180, steam is supplied to the inside of the drum 130 for a predetermined period of time (T1), thereby supplying moisture to the laundry in the drum 130, resulting in soaking contaminants.

Since the steam is in a high temperature state, contaminants of the laundry are soaked efficiently.

Thus, when washing operation is requested by the user, a controller (not shown) controls a steam supply part 180 followed by generating steam so as to supply the generated steam to the drum 130 inside (S110).

The high temperature steam is generated while water supplied in a water storage tub 181 by heat generation of a heat generation part 182 is vaporized. The generated steam is flowed in the drum 130 through a spraying nozzle 184 with being led by a steam supply pipe 183 opened by operation of an opening/closing valve 185.

Supplying the steam to the inside of the drum 130 is continuously performed for a predetermined period of time when the laundry may be fully soaked in the drum 130.

In case that the above steam is supplied for not enough time the steam may not efficiently influence the laundry, thereby the laundry not soaked enough.

In case that the steam is supplied for too long time, an amount of water usage and electric power usage may be relatively large compared with the efficiency of soaking the laundry.

The above laundry soaking is a process of accomplishing a state of contaminants separated from the laundry.

The laundry may be soaked by the steam since contaminants are separated from the laundry influenced by the steam without difficulty, considering the steam is in a high temperature state and includes a large amount of moisture.

When the laundry is severely contaminated, the contaminants may not be completely soaked, but when the laundry is not severely contaminated by the steam, the contaminants may be completely soaked by the steam.

During the steam supply step, the drum 130 is rotated at low speed (S120) the same as the speed in a washing cycle of a conventional washing machine, thereby equally supplying influence of the steam to the laundry.

The temperature of the steam supplied to the drum 130 may be higher than a temperature at which the laundry is sterilized.

Not only performing washing but also sterilizing the laundry at the same time may enhance the user satisfactory.

When the supplying steam for a predetermined period of time is performed to the range that contaminants may be separated from the laundry, a controller controls a steam supply part 180 and stops supplying steam and stops a drive of a drum 130 (S130).

Therewith, the controller performs a contaminant separation step.

For the contaminant separation step, the controller rotates a drum 130 at high speed of more than 2000 RPM by operation control of a motor 171 (S140).

The motor 171 rotates the drum 130 at speed of 3000˜4000 RPM to separate many kinds of contaminants from the laundry by the centrifugal force of the drum 130 rotation at high speed.

Since moisture remains very little in the drum 130, it is possible that the drum 130 is rotated to the range of 3000˜4000 RPM.

That is, in case that a conventional laundry device using a large amount of washing water rotates a drum to the range of 3000˜4000 RPM, a severe vibration may arise, resulting in deteriorating reliability of the laundry device.

However, as in the present invention, an entire washing process is performed using a small amount of steam not a large amount of washing water, so that a drum 130 may be rotated at high speed and the centrifugal force is supplied to contaminants by the high speed rotation of the drum 130 for separating the contaminants from the laundry.

When the drum 130 is rotated to the range of 3000˜4000 RPM, contaminants and moisture contained in the laundry are centrifugally separated from the laundry with being applied by the centrifugal force according to the high speed rotation of the drum 130.

Then the contaminants and moisture separated from the laundry are discharged into an outer tub 120 passing through each hole 131, 132 formed on the drum 130.

When the drum 130 is rotated to the range of 3000˜4000 RPM, the laundry may try to pass through the holes 131 by the centrifugal force.

However, each hole 131 formed in the portion influenced by the laundry has a diameter of less than 1 mm, thereby preventing the laundry from being stuck and damage to the laundry.

Accordingly, only contaminants and moisture centrifugally separated from the laundry are smoothly discharged through each hole 132 having a diameter of more than 1 mm formed on a front circumferential surface so as to enhance discharge efficiency of moisture and contaminants.

As described above, when the centrifugal separation of the contaminants from the laundry for a predetermined period of time is completed, the controller stops the motor 171 and then stops the rotation of the drum 130, therefore completing the entire washing.

The contaminant separation step by high speed rotation of the drum 130 separates not only contaminants but also moisture, thereby the laundry being dried by 70˜95%, an appropriate temperature for ironing.

Thus, an operation method of a laundry device according to a first embodiment of the present invention is capable of washing and drying the laundry by minimized washing water consumption and electricity consumption.

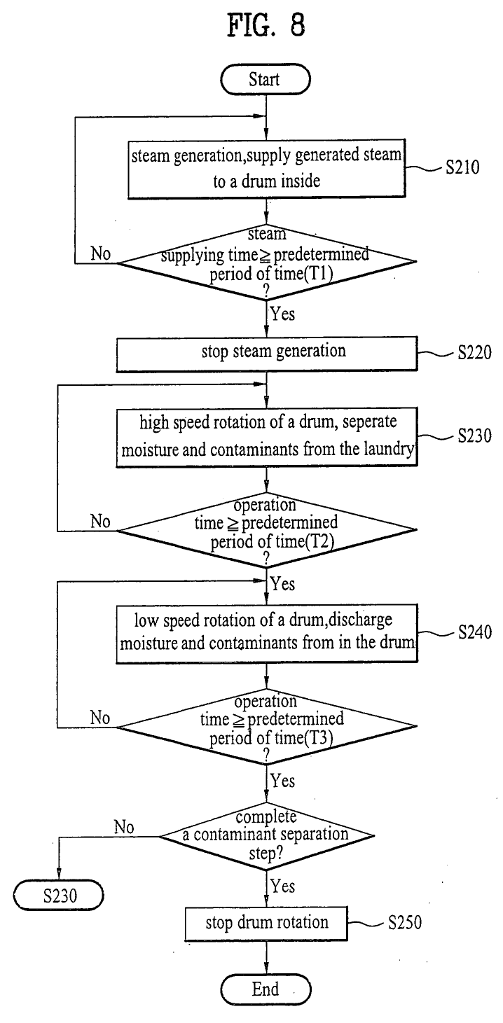

A flow chart in FIG. 8 illustrates an operating method of a laundry machine according to a second embodiment of the present invention.

That is, an operating method of a laundry device according to a second embodiment operates a steam supply step and a contaminant separation step separating contaminants by rotating a drum at a respectively different range of speed.

The steam supply step is operated the same as the steam supply step in a first embodiment of the present invention.

Steam is generated by controlling a steam supply part 180 and the steam is supplied to inside of a drum 130.

After the steam supply step is operated for a predetermined period of time (T1), the steam generation is stopped by the operation control of the steam supply part 180 and then a contaminant separation step starts.

The contaminant separation step comprises a first process centrifugally separating contaminants from the laundry by rotating a drum 130 at high speed, and a second process discharging contaminants, moisture and steam by rotating a drum 130 at relatively lower speed compared with a first process.

The first process and the second process are controlled to be alternately operated to prevent the laundry from re-contaminated by remaining contaminants and moisture in the drum 130.

In case that only the first process is operated, the separated contaminants and moisture from the laundry are not discharged to outside and remain in the drum 130. Because of that, when driving of the drum is stopped, the laundry may be re-contaminated by the remaining contaminants and moisture.

Thus, the first process of rotating the drum 130 at high speed and the second process of rotating the drum 130 at low speed are alternately operated at least once in regular sequence.

The speed of the drum 130 for the first process is more than 2000 RPM, preferably 3000˜4000 RPM, and the speed of the drum 130 for the second process is less than 100 RPM. The speed of the drum 130 for the first process is to the degree that laundry may accomplish a predetermined state of drying. The predetermined state of drying is a state that the laundry is dried to a degree of 70˜95%.

The speed of the drum 130 for the second process is to the degree that steam in the drum 130 may be discharged without difficulty and the contaminants and the moisture separated from the laundry may be discharged to outside without difficulty at the same time.

Also, the operation time of the second process is shorter than the operation time of the second process.

That is to discharge moisture containing contaminants for a short time and to obtain the laundry dryness of 70˜95%.

Moreover, the first process is prior to the second process.

After the moisture and the contaminants contained in the laundry are separated by rotating the drum 130 at high speed for a predetermined period of time (T1), the moisture and the contaminants separated from the laundry are discharged to outside by rotating the drum 130 at low speed (S240) for another predetermined period of time (T3).

When the contaminant separation step is completed by repeatedly operating the first process and the second process, a controller stops rotating the drum 130 (S250) and completes entire washing.

If the contaminant separation step is completed or not is judged by various methods such as judging weight of the laundry or judging humidity in the drum 130. However, in an embodiment of the present an operation time is set up for the contaminant separation step and then counts if time reaches the set up time or not, resulting in judging if the contaminant separation step is completed or not.

Therefore, an operating method of a laundry device according to a second embodiment of the present invention performs entire washing with a minimized washing water consumption and low power consumption.

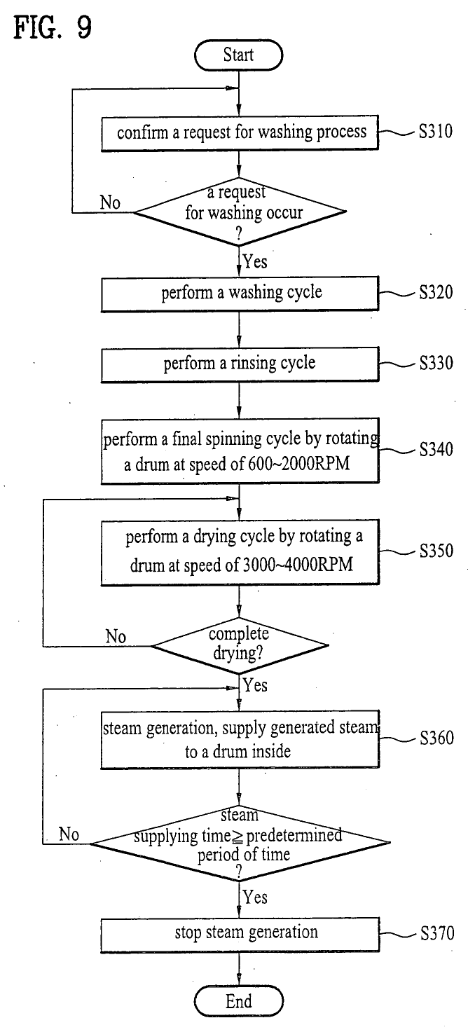

A flow chart in FIG. 9 illustrates an operating method of a laundry device according to a third embodiment of the present invention.

A third embodiment of the present invention comprises a washing cycle, a rinsing cycle, a final spinning cycle and a drying cycle.

The operating method of a laundry device seems similar to an operating method of a conventional laundry device. However, in the operating method of a laundry device according to a third embodiment of the present invention, the drying cycle is performed by rotating a drum 130, while in the conventional operating method of a laundry device the drying cycle is performed by supplying hot air.

More detailed description is the following.

First, a washing cycle (S320) is performed by the user's request for washing (S310).

The washing cycle (S320) uses sulphurization by detergent, frictional force with the laundry and a drum 130, thereby being performed for a predetermined period of time.

When completing the washing cycle, a rinsing cycle (S330) is performed after drainage and spinning.

In the rinsing cycle, at least one rinsing is performed so as to completely remove remaining detergent and foreign substances.

When the rinsing cycle is completed and washing water used in rinsing is drained, a final spinning cycle (S340) is performed.

In the final spinning cycle (S340), the rotation speed of the drum 130 is set up between 600 RPM and 2000 RPM.

The final spinning cycle is set up so as to minimize moisture contained in the laundry.

In the drying cycle after completing the final spinning cycle, the drum 130 is rotated at more than 2000 RPM. Thus if moisture content is large in the inside of the drum 130, severe vibration may occur when rotating the drum 130 for the drying cycle, thereby deteriorating reliability for a washing machine.

Before the drying cycle, moisture contained in the laundry is minimized. In an third embodiment of the present invention, the final spinning cycle accomplishes a state for the drying cycle.

When the final spinning cycle is completed, a drying cycle (S250) performs drying the laundry by rotating the drum 130 at high speed.

The speed of the drum 130 rotation in the drying cycle is higher than the speed in the final spinning cycle.

Moisture contained in the laundry is separated from the laundry by the centrifugal force according to the rotation of the drum 130 at high speed of more than 2000 RPM, thereby obtaining the same effect as a drying effect of using hot air supplying in an operating method of a conventional laundry device.

For a maximized drying efficiency, the rotation speed of the drum 130 is approximately 3000˜4000 RPM.

The drum may be rotated at speed of 2000˜3000 RPM for drying, however laundry dryness the user is expecting cannot be accomplished for a short time.

The drum 130 also may be rotated at speed of more than 4000 RPM so as to perform drying, however it may cause a problem of deteriorating reliability of a laundry device. The above high speed is beyond capability of a conventional laundry device, thereby causing breakage of the parts.

The range of the drum rotation speed is between 3000 RPM and 4000 RPM for the minimized drying effect and preventing deteriorating reliability.

When the drying cycle is performed by rotating the drum 130 at a high speed of 3000˜4000 RPM for a predetermined period of time, moisture contained in the laundry is separated by the centrifugal force according to the high speed rotation of the drum 130.

The drying cycle is performed until the laundry is dried by 70˜95%.

A method for judging the time of stopping the drying cycle according to dryness of the laundry is to repeatedly confirm humidity in the drum 130 by a humidity sensor.

Also, when the drum 130 is rotated at a high speed for a predetermined period of time according to an amount of washing water, it is judged that expected dryness is satisfied and then the drying cycle is stopped.

When steam is generated by operating a steam supply part 180 after the drying cycle completed, a steam supply step (S260) for spraying the generated steam into the drum 130 is performed.

The steam is directly sprayed to the laundry in spray state and the spraying pressure is to a degree that anions may be generated by shock power when the steam is collided with the laundry.

By the anions, not only static electricity of the laundry but also ill-smell of the laundry may be removed

The anions may be generated when the steam in spray state is collided not only with the laundry but also with the wall side of the drum 130.

The steam is supplied at a temperature of more than 60° C. at which the laundry may be sterilized. The steam temperature of 70° C. is preferable but not necessary.

The steam supply step is performed for a predetermined period of time for refreshing the dried laundry.

The refreshing the dried laundry is a process that wrinkles from the laundry may be smoothed out. In other words, wrinkles from the laundry may be smoothed out by spraying high temperature moisture in steam state to the laundry just like a steam iron.

In the drying cycle as described above, the laundry may be smoothly ironed by the refresh effect, while drying the laundry too much may have a problem that causes ironing the laundry difficult.

However, when the refresh process is performed too long, an amount of steam supplied to the laundry is too much, resulting in causing the laundry wet. Thus, the refresh process may be operated for an appropriate time for example 3˜10 minutes.

It is preferred but not necessary that during the refresh process the drum 130 is controlled to be rotated for equally removing static electricity and obtaining the refresh effect.

When the steam spraying is performed for a predetermined period of time, steam generation is stopped (S270) by stopping the steam supply part 180 operation and then a process for removing static electricity is completed, thereafter the entire washing completed.

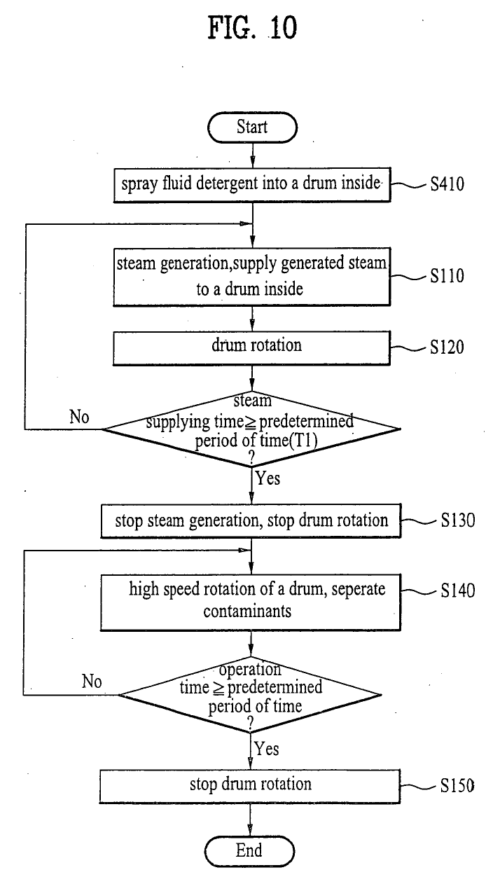

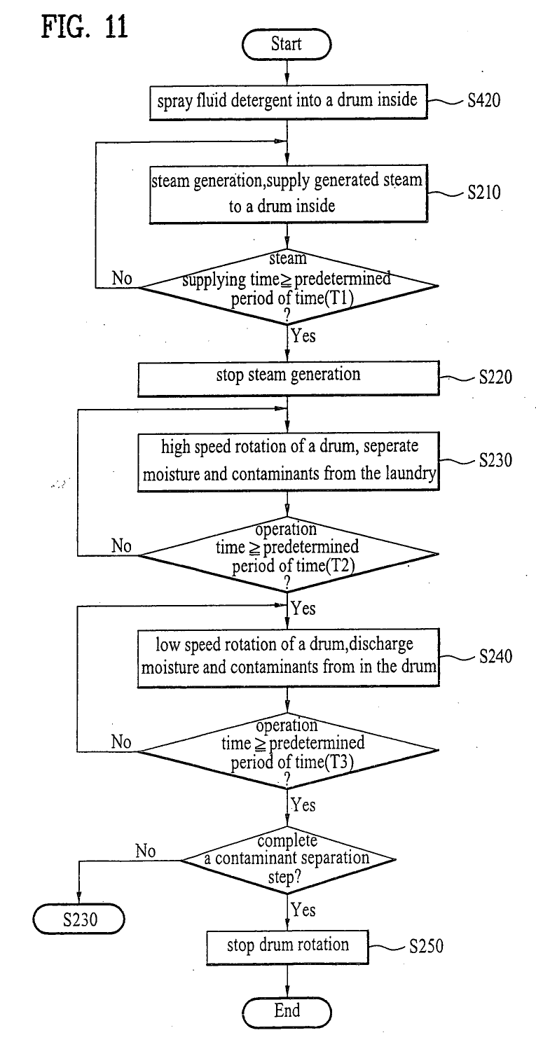

Flow charts in FIGS. 10 and 11 illustrate an operating method of a laundry device according to a fourth embodiment of the present invention.

In other words, in an operating method of a laundry device according to a fourth embodiment of the present invention, a soaking step for separating contaminants from the laundry may be performed not only by simply steam but also by sulphurization of detergent.

That is because in operating methods of a laundry device shown in a first embodiment and a second embodiment it is difficult to obtain the washing efficiency the user expects in case that there are a lot of contaminants in the laundry.

Therefore, in an operating method of a laundry device according to a fourth embodiment of the present invention, a detergent supply step (S410, S420) for supplying detergent to an inside of a drum 130 is further included before the steam supply step for supplying steam to the drum inside.

The detergent is sprayed into the drum with the steam in fluid spray state, thereby enhancing the efficiency of the detergent permeating through the laundry. Thus, the detergent may be fluid highly concentrated detergent.

The detergent supply step may be performed at the same time with the steam supply step, thereby the detergent and the steam being supplied to the inside of the drum 130 together.

For the operating method of a laundry device according to a fourth embodiment of the present invention performing, a structure for spraying the fluid highly concentrated detergent into the drum 130 in spray state is further needed.

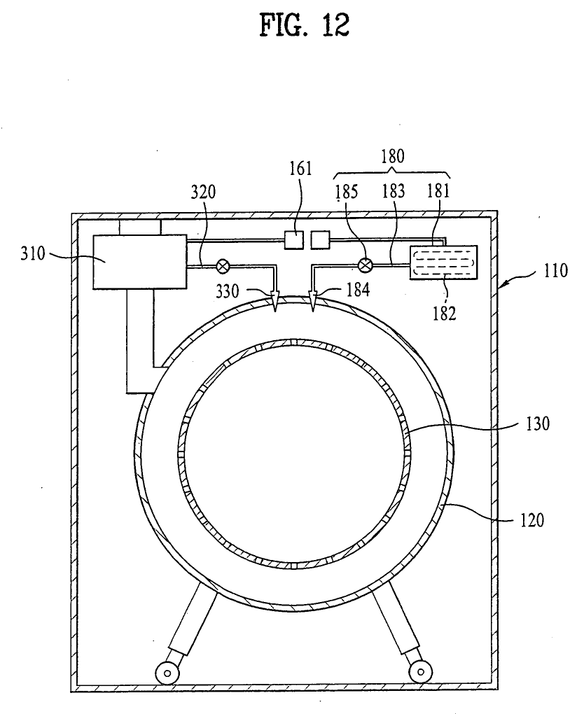

Thereby, shown in FIG. 12, a detergent supply part is further provided in a laundry device according to an embodiment of the present invention.

The detergent supply part comprises a detergent box 310 for storing fluid detergent, a detergent supply pipe 320 for leading the fluid detergent to a drum 130, and a spray nozzle 330 provided at an end of the detergent supply pipe 320 for spraying detergent in spray state flowed along the detergent supply pipe 320.

As described in an operating method of a laundry according to a fourth embodiment of the present invention, although a small amount of detergent is supplied to the laundry, enough rinsing for the detergent should be accomplished.

In case that enough rinsing for the detergent is not accomplished, a problem may arise that the laundry has a stain caused by remaining detergent.

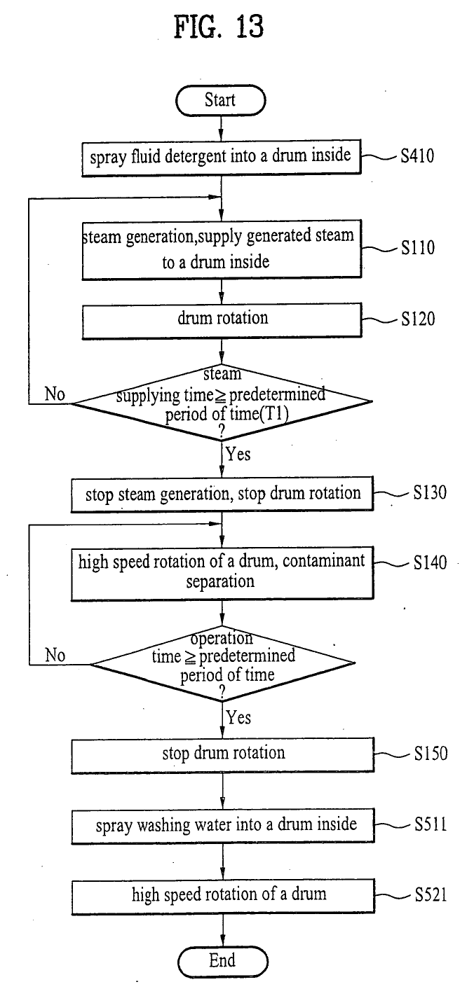

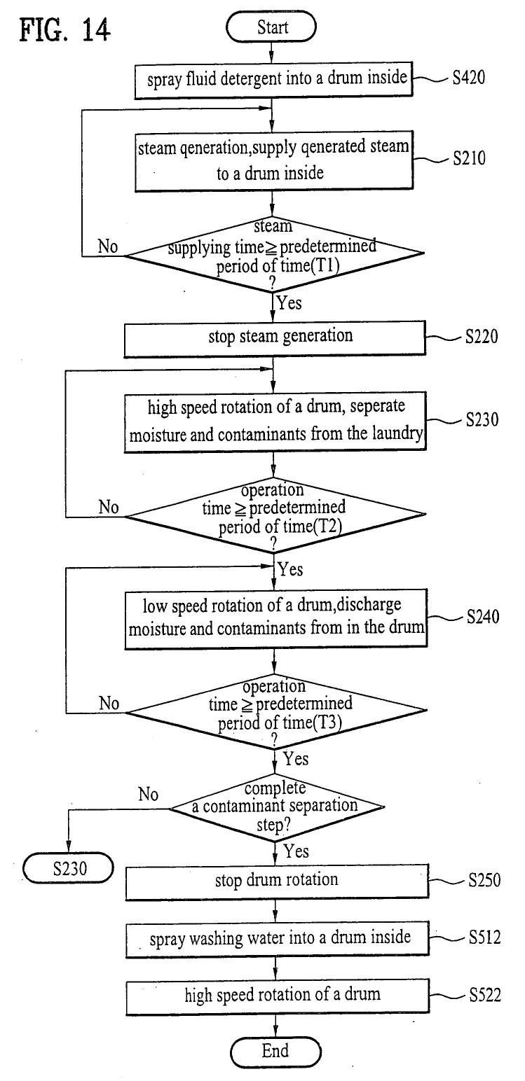

Thus, as shown in flow charts in FIGS. 13 and 14, an operating method of a laundry device according to a fifth embodiment of the present invention further comprises a rinsing step in the steps of an operating method of a laundry device according to a fourth embodiment of the present invention.

The rinsing step may be performed right after the steam supply step is completed, however it is preferred but not necessary that the rinsing step is performed after the contaminant separation step by the high speed rotation of the drum 130 is completed (S511, S512).

After the rinsing step completed, a spinning step is performed (S521, S522) at high speed of the re-rotation of the drum 130, approximately 2000˜4000 RPM or at rotation speed for general spinning, approximately 800˜1300 RPM.

Also, during the rinsing step, washing water is sprayed toward the laundry in the drum 130 for rinsing the laundry.

During the rinsing step, steam also may be re-sprayed.

For the rinsing step a washing water spray part is provided for supplying additional washing water just like a detergent supply part for supplying detergent and a steam supply part for supplying steam.

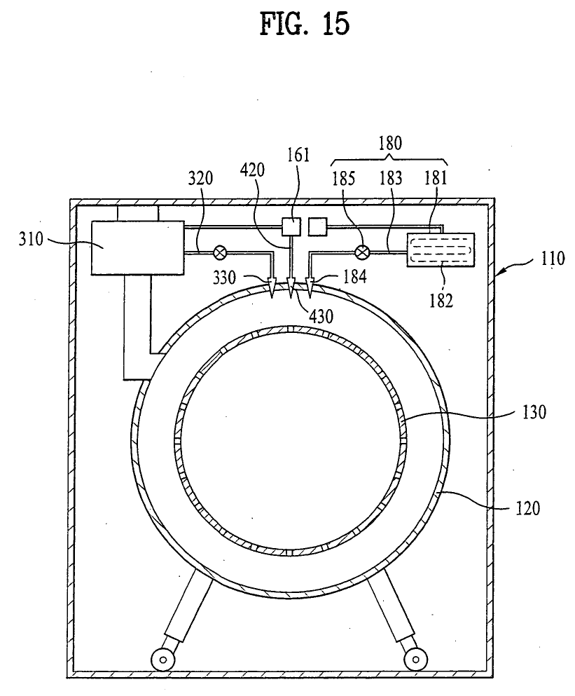

As shown in FIG. 15 the washing water spray part comprises a washing water supply pipe 420 for leading washing water flow to the inside of the drum 130 and a spray nozzle 430 provided at an end of the washing water supply pipe 420 for spraying the washing water flowed along the washing water supply pipe 420.

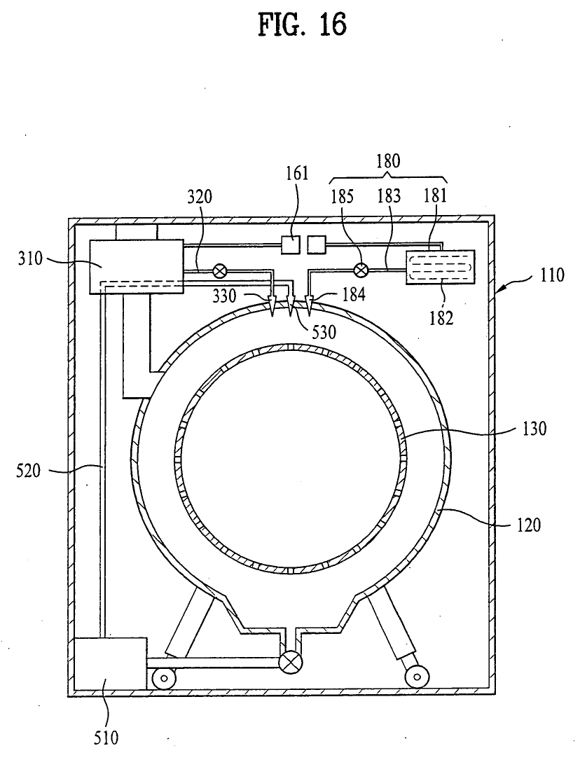

As shown in FIG. 16, the washing water spray part circulates washing water in an outer tub 120 and sprays the washing water toward the inside of the drum 130. Then, 510 (with no description) is a circulation pump, 520 (with no description) is a washing water supply pipe and 530 (with no description) is a spray nozzle.

Preferably, after the rinsing step the drum may be re-rotated at high speed, thereby centrifugally separating contaminants generated by the rinsing step from the laundry.

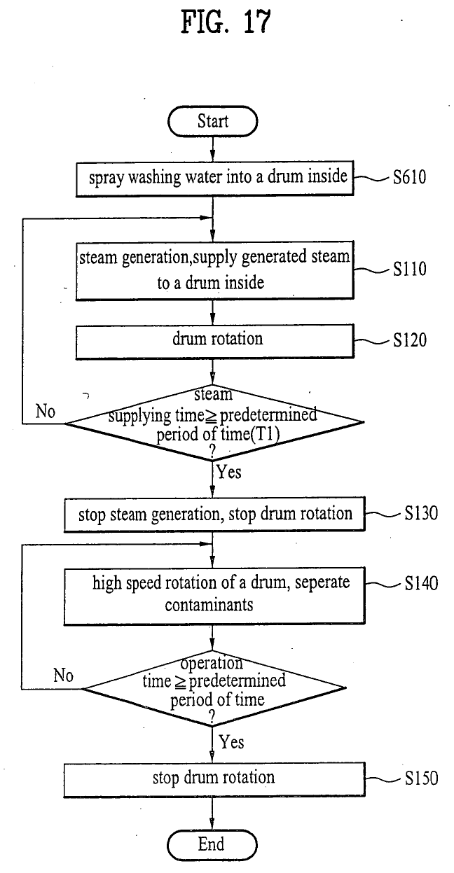

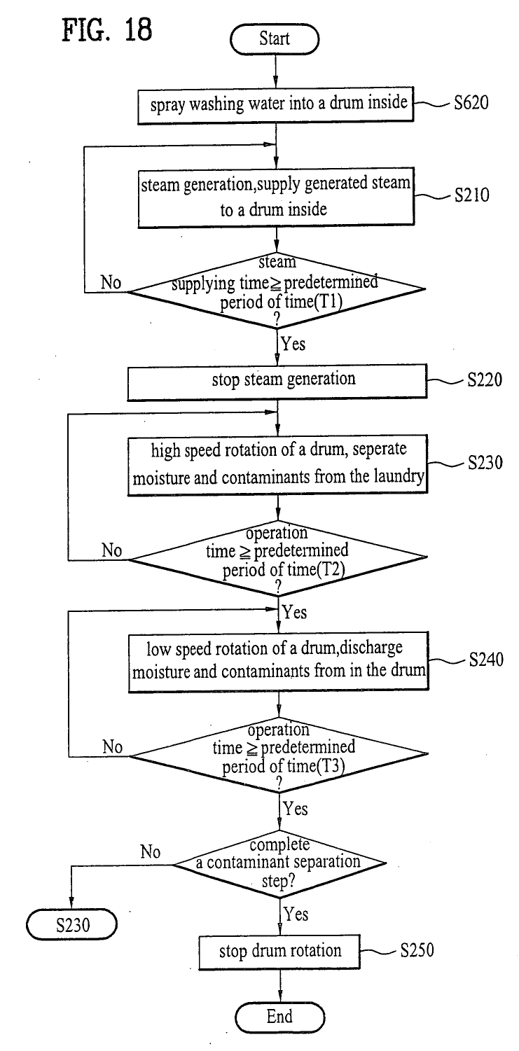

As shown in flow charts in FIGS. 17 and 18, an operating method of a laundry device according to a sixth embodiment of the present invention further includes a washing water spray step (S610, S620) for spraying washing water in the drum 130 before the steam supply step in an operating method of a laundry device according to a first embodiment and a second embodiment of the present invention.

The washing water is cold water not boiled because contaminant separation from the laundry may be facilitated by washing water in cold state, considering steam sprayed toward the laundry is in high temperature state in the next steam supply step (S10, S210).

The laundry is contracted and expanded in a regular sequence by a temperature difference, resulting in facilitating the contaminant separation from the laundry.

Also, a contaminant separation for facilitation step using washing water spray may be further included in the steps according to a fourth embodiment of the present invention.

In other words, first, washing water in cold water state is sprayed in the drum 130, second, a soaking step is operated for contaminant separation by supplying detergent and steam, and last, the drum 130 is rotated at high speed with stopping the steam after a predetermined period of time, thereby centrifugally separating the contaminants from the laundry.

The rotation speed of the drum 130 for the centrifugal separation of the contaminants may be 3000˜4000 RPM as described in a first embodiment and a second embodiment of the present invention. The detergent supplied to the inside of the drum may be concentrated detergent in fluid spray state as described in a fourth embodiment and a fifth embodiment of the present invention.

A structure of a laundry device described in an embodiment of the present invention includes a drum 130 and a motor 171. A plurality of holes 131 having each diameter of less than 1 mm is formed along a circumferential surface of the drum and the motor 171 is driven for rotating the drum 130 at speed of at least 2000 RPM. The above structure of a laundry device described in an embodiment of the present invention is not applied to only a drum type washing machine.

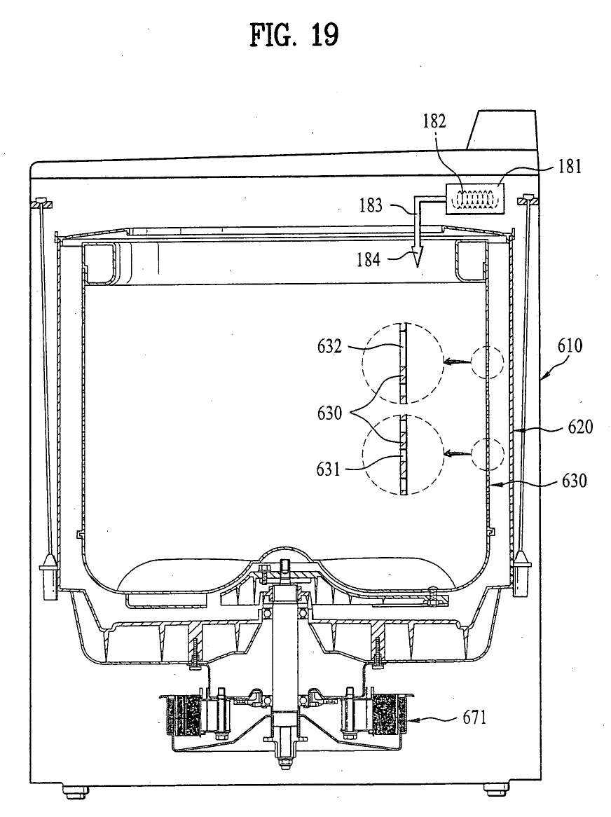

The above structure of a laundry device is also applied to a pulsator type washing machine in which an opening side for laundry introduction of the drum 630 is mounted facing an upper part of a body 610, as shown in FIG. 19.

Then, on the circumferential surface of the drum 630, not only holes 631 having each diameter of less than 1 mm are formed but also at least one and more holes 632 having each diameter of more than 1 mm are further formed for enhancing efficiency of discharging moisture and contaminants.

The holes 632 having each diameter of more than 1 mm are may be formed on an upper circumferential surface of the drum 630 so as to minimize a problem of the laundry being stuck.

That is because the laundry is located in a lower side of the inside of the drum 630 by its own gravity considering the drum 630 is stood in a perpendicular direction and an upper side of the drum 630 is not influenced by the laundry.

The motor 671 is combined by a shaft passing through a lower side of an outer tub 620 to the drum 630 or a pulsator.

As shown in a pulsator type washing machine according to another embodiment of the present invention, a steam supply part 180 may be further comprised. The steam supply part 180 includes a water storage tub 181, a heat generation part 182, a steam supply pipe 183 and a spray nozzle 184.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The laundry device according to an embodiment of the present invention may have an industrial applicability, since it is a structure of a laundry device for washing the laundry.

The operation methods of a laundry method according to a first embodiment and a second embodiment of the present invention may have an industrial applicability, since they are operating methods of a laundry device for the maximized washing efficiency with minimized electric power consumption.

The operating method of a laundry according to a third embodiment of the present invention may have an industrial applicability, since it is a general control method for washing the laundry.

The operating method of a laundry device according to a fourth embodiment of the present invention may have an industrial applicability, since it is a control method for separating contaminants from the laundry without difficulty by using not only steam but also detergent.

The operating methods of a laundry device according to a fifth embodiment and a sixth embodiment of the present invention may have an industrial applicability, since they are control methods for accomplishing contaminant separation from the laundry rapidly,

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A laundry device comprising:
a body;
a drum provided in the body, thereon a circumferential surface a plurality of holes having each diameter of less than 1 mm being formed; and
a motor driven for rotating the drum at high speed of at least and more 2000 RPM.

2. The laundry device as claimed in claim 1, wherein at least one and more holes having each diameter of more than 1 mm are further formed on a circumferential surface of the drum.

3. The laundry device as claimed in claim 2, wherein the number of holes having each diameter of more than 1 mm is smaller than the number of holes having each diameter of less than 1 mm.

4. The laundry device as claimed in claim 1, wherein the drum is installed more inclined downward coming along from a front surface to a rear surface, and at least one and more holes having each diameter of more than 1 mm may be formed on a front circumferential surface.

5. The laundry device as claimed in claim 1, wherein the drum is installed thereof an opening for introduction of laundry facing an upper part and on an upper circumferential surface at least one and more holes having each diameter of more than 1 mm are formed.

6. The laundry device as claimed in claim 1, wherein the motor is driven for rotating the drum at high speed of 3000˜4000 RPM.

7. The laundry device as claimed in claim 1, further comprising a steam supply part in the body for spraying high temperature steam into the drum.

8. The laundry device as claimed in claim 1, further comprising a detergent supply part in the body for spraying fluid detergent in spray state into the drum.

9. The laundry device as claimed in claim 1, further comprising a washing water spray part in the body for spraying washing water into the drum.

10. A method for operating a laundry device comprising:
a (a) step for supplying steam to an inside of a drum where the laundry is introduced;
a (b) step for stopping steam supply after a predetermined period of time; and
a (c) step for centrifugally separating contaminants from the laundry by rotating the drum at high speed.

11. The method for operating a laundry device as claimed in 10, wherein the temperature of steam supplied in the (a) step is higher than a temperature at which the laundry may be sterilized.

12. The method for operating a laundry device as claimed in 10, wherein the predetermined period of time in the (b) step is the time when the laundry maybe soaked by the steam.

13. The method for operating a laundry device as claimed in 10, wherein the rotation speed in the (c) step is 2000˜4000 RPM.

14. The method for operating a laundry device as claimed in 10, further comprising a (d) step alternately operated with the (c) step at relatively lower speed than the rotation speed in the (c) step for discharging steam in the drum.

15. The method for operating a laundry device as claimed in 14, wherein the speed for operating the (d) step is lower than 100 RPM.

16. The method for operating a laundry device as claimed in 14, wherein the time for operating the (d) step is shorter than the time for rotating the drum at high speed.

17. The method for operating a laundry device as claimed in 10, further comprising a (e) step for spraying washing water in the drum before the steam in the (a) step is supplied to the inside of the drum.

18. The method for operating a laundry device as claimed in 17, wherein the washing water sprayed in the (e) step is in cold water state not boiled.

19. The method for operating a laundry device as claimed in 17, further comprising a (f) step for spraying fluid detergent to the laundry before the (e) step.

20. The method for operating a laundry device as claimed in 19, wherein the detergent supplied in the (f) step is concentrated detergent in fluid spray state.

21. The method for operating a laundry device as claimed in 19, further comprising a (g) step for rinsing the laundry by spraying steam or washing water in the drum after the (f) step.

22. The operating method of a laundry device as claimed in 10, wherein during the (a) step a drum is rotated at low speed.

23. A method for operating a laundry device comprising:
a (h) step for performing a washing cycle for a predetermined period of time;
a (i) step for performing at least one and more rising cycle when the (h) step is completed;
a (j) step for performing a final spinning cycle by rotating a drum at high speed when the (i) step is completed; and
a (k) step for performing a dry cycle by rotating the drum at higher speed than the speed in the final spinning cycle when the final spinning cycle is completed.

24. The method for operating a laundry device as claimed in 23, wherein the speed of the drum rotation in the (j) step is set up between 600 RPM and 2000 RPM.

25. The method for operating a laundry device as claimed in 23 wherein the speed of the drum rotation in the (k) step is set up between 3000 RPM and 4000 RPM.

26. The method for operating a laundry device as claimed in 23, further comprising a (l) step for supplying steam to the dried laundry in the drum when the (k) step is completed.

27. The method for operating a laundry device as claimed in 26, wherein the temperature of the steam supplied in the (l) step is higher than a temperature at which the laundry may be sterilized.

28. The operating method of a laundry device as claimed in 26, wherein the (l) step is performed for a predetermined period of time enough to refresh the laundry in the drum.

29. The method for operating a laundry device as claimed in 14, further comprising a (e) step for spraying washing water in the drum before the steam in the (a) step is supplied to the inside of the drum.
